(19) United States
(12) Patent Application Publication
(10) Pub. No.: US 2025/0141148 A1
(43) Pub. Date: May 1, 2025

(54) CONNECTION ADAPTER FOR MECHANICALLY FASTENING ELECTRICAL CONNECTORS OF VARIOUS STRUCTURAL TYPES

(71) Applicant: Weidmüller Interface GmbH & Co. KG, Detmold (DE)

(72) Inventors: Tobias LANGER, Lemgo (DE); Marc REGER, Lage (DE)

(21) Appl. No.: 18/925,271

(22) Filed: Oct. 24, 2024

(30) Foreign Application Priority Data
Oct. 25, 2023 (DE) 102023129408.3

(51) Int. Cl. H01R 13/514; H01R 13/627; H01R 13/66; H01R 13/717

(52) U.S. Cl. CPC H01R 13/514; H01R 13/6275; H01R 13/6658; H01R 13/717

(57) ABSTRACT

A connection adapter for mechanically fastening electrical connector panels of various structural types to one another to form a higher-level connector arrangement includes a housing on which first fastening mechanisms assigned to a first structural type are arranged on the stacking front and second fastening mechanisms assigned to a second structural type are arranged on the stacking back. The first fastening mechanisms are provided for fastening a first electrical connector panel of the first structural type against a stacking direction to the connection adapter. The second fastening mechanisms are provided for fastening a second electrical connector panel of the second structural type in the stacking direction to the connection adapter. A connector arrangement includes the connection adapter and at least one electrical connector panel.

### BACKGROUND

The present invention relates to a connection adapter for mechanically fastening electrical connector panels of various structural types, which can be stacked in a stacking direction to one another to form a higher-level connector arrangement. The present invention further relates to a connector arrangement including a connection adapter.

To connect electrical conductors to electrical assemblies and/or circuits, such as printed circuit boards, it is known to use a plurality of electrical connectors which are connectable to mating connectors arranged on the printed circuit boards, in particular insertable therein. Depending on the application, the connectors as well as the corresponding mating connectors differ in terms of the number and the cross-section of the connectable electrical conductors, their dimensions, such as printed circuit board grid pitch, their size, their design and/or their handling. Multiple such connectors are frequently arranged next to one another. These can be produced in one piece or formed from connector panels stacked onto one another in a stacking direction.

In the case of elaborate electrical devices, connectors of various structural types can be required for the devices to provide all of the electrical functions needed (e.g. electrical voltage supply, signal lines, communication). Due to the frequently small installation space available and/or the clear visibility of the electrical devices, it can be advantageous to arrange the connectors of the various structural types as closely as possible to one another. This makes them accessible to a fitter, in particular from the same assembly or maintenance side.

### SUMMARY OF THE INVENTION

It is therefore an object of the present invention to provide a connection adapter for mechanically connecting electrical connector panels of various structural types, which can be stacked in a stacking direction to one another to form a higher-level connector arrangement. The connection adapter has a housing constructed of insulating material. Fastening mechanisms assigned to a first structural type are arranged on the stacking front of the housing, which are provided for fastening a first electrical connector panel of the first structural type against a stacking direction to the connection adapter. In addition, fastening mechanisms assigned to a second structural type are arranged on the stacking back of the housing, which are provided for fastening a second electrical connector panel of the second structural type in the stacking direction to the connection adapter. On the stacking front of the housing is a first adapter part for adapting the first connector panel, and on the stacking back of the housing is a second adapter part for adapting the second connector panel.

A connector arrangement is created easily and quickly by stacking the first electrical connector panel of the first structural type against the stacking direction on the connection adapter, in particular on the first adapter part, and by stacking the second electrical connector panel of the second structural type in the stacking direction on the connection adapter, in particular on the second adapter part. The adapted connector panels are arranged close to one another in a clear and space-saving manner. Since the adapted connector panels are mechanically connected to one another by the connection adapter, they can be handled together. The fastening mechanisms guarantee a secure mechanical connection of the connector panels to the connection adapter, which does not automatically release even in demanding surroundings such as under the stress of heavy vibrations.

In a preferred configuration, the fastening mechanisms can comprise positioning and clamping mechanisms such as corresponding pins and recesses and/or corresponding latching mechanisms. Fastening the first connector panel the second connector panel against or in the stacking direction to the connection adapter, can be affected by a complex sequence of movements in which the respective connector panel is adjusted, in particular displaced and/or rotated in various spatial directions relative to the connection adapter. It is, however, preferable that fastening the respective connector panel is affected by a displacement, or fitting, of the connector panel either in or against the stacking direction onto the connection adapter.

The connection adapter is preferably configured in the form of a panel having a housing with a back wall extending in a planar manner on the stacking back to a narrow wall is connected thereto. The narrow wall is preferably arranged at the edge of the back wall and extends at an angle to the back wall at least in certain areas or predominantly transversely thereto. In a preferred embodiment, the narrow wall is substantially circumferentially closed. Here, the wording “substantially circumferentially closed” includes a narrow wall which has a through-opening for guiding an electrical conductor or an electrical part through. The housing of this embodiment has an approximately pot configuration, and the back wall can have an approximately rectangular configuration. The back wall and the narrow wall delimit an inner space having an opening at least on the stacking front of the housing. The inner space is easily accessible from the outside through the opening.

In a preferred embodiment, the inner space is provided for receiving at least one electrical component, in particular an electrical part or an electrical assembly, which can be operated by a battery. It is preferable for the connection adapter to include a blind housing part which is optionally provided for receiving a plug or a socket. The blind housing part forms a plugging face of the connection adapter, which protrudes from the narrow wall in an insertion direction extending transversely to the stacking direction with an open end. As a result, the connection adapter can be inserted into a plugging face of a mating connection adapter.

In a likewise preferred embodiment, the electrical component comprises an electrical printed circuit board, which can be latched, snapped or screwed onto the housing, in particular into the inner space. In this embodiment, by using the smallest electrical parts, such as SMD parts which are arranged on the printed circuit board and electrically wired up to one another, the electrical component can comprise a relatively elaborate electrical circuit which can be arranged in the inner space of the connection adapter.

A plug or a socket received in the blind housing part is preferably provided to supply voltage to the electrical component. For that reason, it is preferable that the plug or the socket, which electrically contacts the printed circuit board, is arranged in the blind housing part.

Additionally or alternatively, the plug or the socket for transmitting signals can be provided for communication of the electrical component with at least one of the adapted first or second connector panels. It is thus preferable that the plug or the socket is provided to establish an electrically conductive connection between a communication interface of the electrical component and a communication interface of the respective connector panel. Likewise, the plug or the socket can preferably be provided to establish an electrically conductive connection between the communication interface of the electrical component and a communication interface of a mating connection adapter which can be connected to the connection adapter, or of an electrical assembly to which said mating connection adapter is connected.

In another preferred embodiment, one or more electrical connection mechanism for contacting at least one of the adapted first or second connector panels are provided on the housing stacking back or stacking front. These electrical connection mechanisms are also preferably provided for voltage supply and/or for communication of the electrical component with the adapted connector panels. They then establish the electrically conductive connection between the electrical component and the respective connector panel. Furthermore, the electrical connection mechanisms and/or the electrical component can connect the first electrical connector panel and the second electrical connector panel directly to one another in an electrically conductive manner.

A further preferred embodiment envisages that the electrical component is embodied to identify the structural types of at least one of the adapted first electrical connector panels or second electrical connector panel. Additionally or alternatively, at least one indicating mechanism for indicating a status of at least one of the adapted first or second electrical connector panels can be provided in or on the housing. The indicating mechanism is preferably a lighting mechanism, such as an LED. However, other indicating mechanisms are preferred, such as a 7-segment indication or a display.

In a further preferred embodiment, the connection adapter has a locking mechanism which is provided for locking the connection adapter to a mating connection adapter. The locking mechanism is preferably arranged in the inner space but can be alternatively or additionally received in the inner space to the electrical component. The locking mechanism guarantees secure mechanical locking of the connection adapter to the mating connection adapter. As a result, they cannot be released from one another automatically in demanding surroundings, in particular those subject to heavy vibrations.

For that reason, the locking mechanism is preferably configured as a lever which can be reversibly adjusted from a latching position into a releasing position by displacement and/or swivelling. A latching hook is preferably arranged on the lever. In the latching position, the latching hook can interact in a latching manner with a mating latching hook of the mating connection adapter. It is preferable for the lever to completely push through the inner space of the connection adapter in the insertion direction. The latching hook preferably protrudes from the inner space to be inserted into the mating connection adapter in the insertion direction and pushed through a first through-opening in the narrow wall. Furthermore, it is preferable to provide an actuation mechanism on the lever for manually actuating the lever. The actuation mechanism preferably protrudes from the housing so that it is accessible from the outside. The lever pushes through a second through-opening in the narrow wall which can be arranged opposite the first through-opening.

It is further an object of the present application to provide a mating connection adapter which is provided for mechanically fastening electrical mating connector panels of various structural types to one another to form a higher-level mating connector arrangement. The mating connection adapter is preferably configured in a corresponding manner to the connection adapter, so that the connection adapter and the mating connection adapter can be inserted into one another, locked to one another and/or electrically connected to one another. The mating connection adapter can have the same features as the connection adapter described above and can be handled in a similar manner.

It is further an object of the present invention to provide a connector arrangement comprising at least one first connector panel of a first structural type and/or at least one second connector panel of a second structural type as well as the connection adapter described herein. The first connector panel is fastened to the connection adapter on the stacking front thereof, and/or the second connector panel is fastened to the connection adapter on the stacking back thereof. The first connector panel is arranged on the connection adapter against the stacking direction, and the second connector panel is arranged on the connection adapter in the stacking direction. A first adapter part with fastening mechanisms for fastening the first connector panel of the first structural type is configured on the stacking front of the connection adapter, and a second adapter part with fastening mechanisms for fastening the second connector panel of the second structural type is configured on the stacking back of the connection adapter. For that reason, the fastening mechanisms of the connection adapter are configured in a corresponding manner to mating fastening mechanisms of the respective connector panel.

It is preferable that multiple first connector panels can be stacked on one another in each case to form a first connector, and/or multiple second connector panels can be stacked on one another in each case to form a second connector. The connector panels each have the fastening mechanisms of the first or second adapter part on the stacking front or on the stacking back, and the mating fastening mechanisms corresponding thereto on the opposite side in each case.

It is therefore preferable that the fastening mechanisms of the connection adapter of the connector arrangement on the stacking front are configured identical in construction to first fastening mechanisms and in a corresponding manner to first mating fastening mechanisms of the first connector panel or of the first connector of the first structural type. On the stacking back, the fastening mechanisms of the connection adapter are configured identical in construction to second fastening mechanisms and in a corresponding manner to second mating fastening mechanisms of the second connector panel or of the second connector of the second structural type.

The first and the second connector panels each preferably have at least one connection terminal for electrically connecting electrical conductors to a corresponding electrical mating connector panel or a corresponding electrical mating connector. In a preferred embodiment, the connection terminal is configured as a direct connection terminal (e.g. snap-in). Other connection forms such as push-in are also conceivable.

The connection adapter makes it possible to simply and quickly attach a connector panel of a first structural type, or a connector comprising multiple connector panels of the first structural type, to a connector panel of a second structural type, or to a connector comprising multiple connector panels of the second structural type. This creates a cost-effective arrangement, which is quick to assemble, to locate complex connector arrangements in a space-saving and clearly visible manner.

The object of the present application further a mating connector arrangement including at least one first mating connector panel of a first structural type and/or at least one second mating connector panel of a second structural type, as well as a mating connection adapter as described herein. The first mating connector panel is fastened to the mating connection adapter on the stacking front thereof, and the second mating connector panel is fastened to the mating connection adapter on the stacking back thereof.

Similarly, the mating connection adapter makes it possible to simply and quickly attach a mating connector panel of a first structural type, or a mating connector comprising multiple mating connector panels of the first structural type, to a mating connector panel of a second structural type, or to a mating connector comprising multiple mating connector panels of the second structural type. This creates a cost-effective arrangement, which is quick to assemble, for locating complex mating connector arrangements in a space-saving and clearly visible manner.

### BRIEF DESCRIPTION OF THE DRAWINGS

The invention will be described below with reference to figures. The figures are merely exemplary and do not limit the general inventive concept. In the drawings:

FIGS. 1a and 1b are perspective views of a first embodiment of a connection adapter;

FIGS. 2a-2d are exploded, perspective, side and sectional views, respectively, of a connector arrangement with the connection adapter of FIG. 1;

FIG. 3 is a perspective view of the connector arrangement from FIG. 2, wherein connectors including multiple connector panels of one structural type are arranged on the front and stacking back of the connection adapter;

FIGS. 4a-4c are exploded, left perspective and right perspective views, respectively, of a connector arrangement having a connection adapter of a further embodiment; and

FIG. 5a is a perspective view of a connector arrangement having a further embodiment of a connection adapter; and

FIGS. 5b-5c are sectional views of the connection adapter of FIG. 5a.

### DETAILED DESCRIPTION

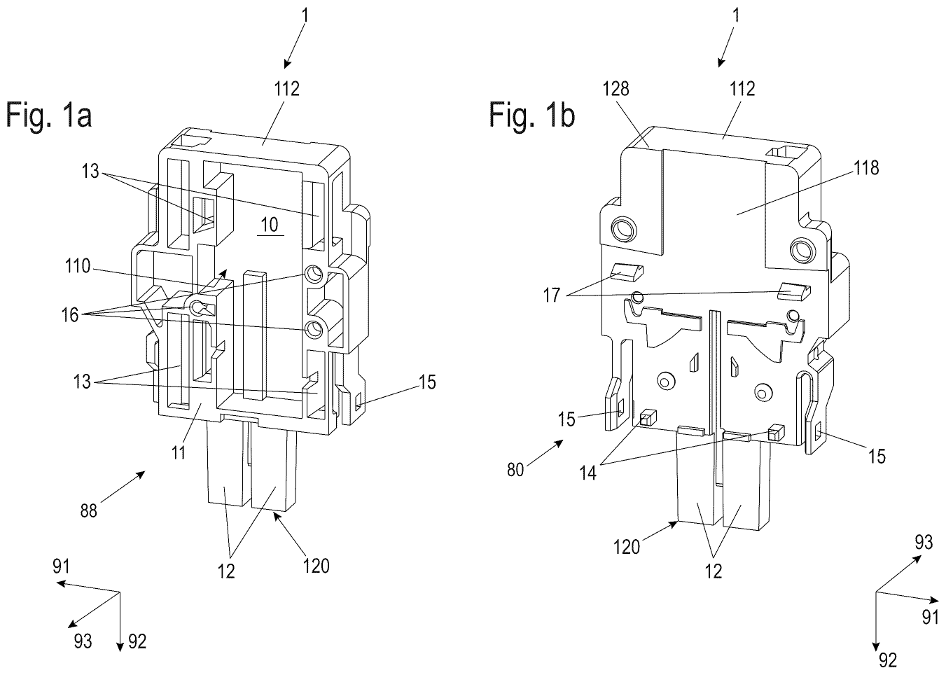

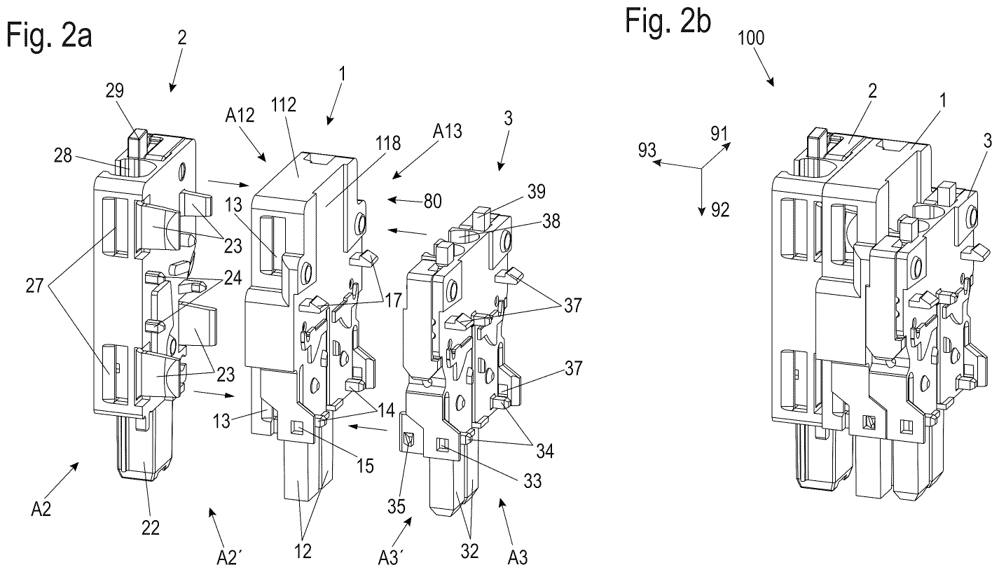

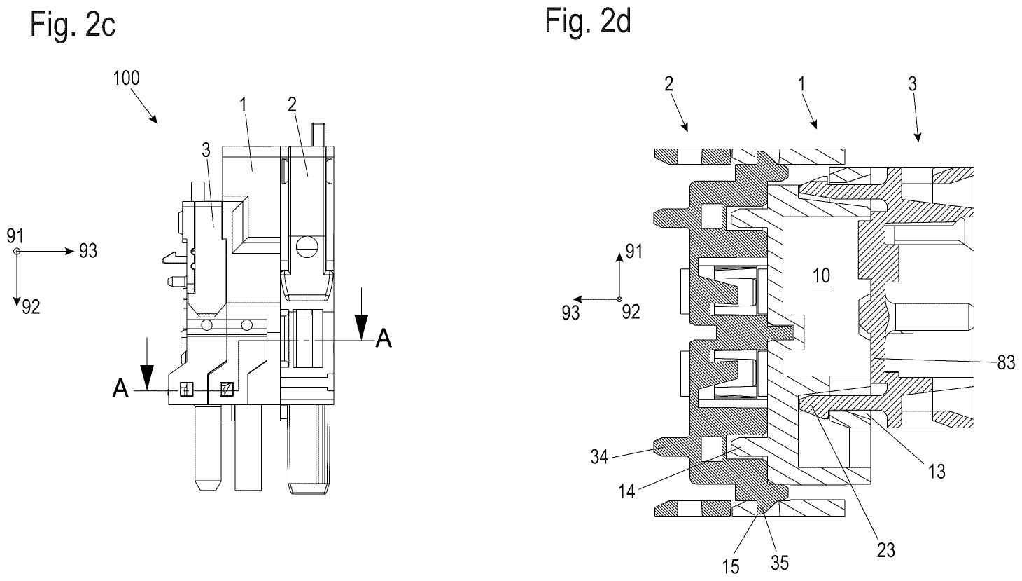

FIGS. 1a and 1b are perspective views of a first embodiment of a connection adapter 1. The connection adapter 1 is provided for mechanically connecting electrical connector panels 2, 3 (see FIGS. 2a-2d) of various structural types to one another to form a higher-level connector arrangement 100.

The connection adapter 1 has a housing 11 produced from an insulating material such as, for example, a plastic 11. The housing 11 has a stacking front 88 and a stacking back 80. Fastening mechanisms 13, 16 assigned to a first structural type are arranged on the housing 11 on the stacking front, which are provided for fastening a first electrical connector panel 2 (see FIGS. 2a-2d) of the first structural type against a stacking direction 93 to the connection adapter 1. The housing 11 includes on its stacking front 88 a first adapter part A12 (see FIG. 2a) for adapting the first connector panel 2.

In addition, fastening mechanisms 14, 15, 17 assigned to a second structural type are arranged on the stacking back of the housing 11, which are provided for fastening a second electrical connector panel 3 (see FIGS. 2a-2d) of the second structural type in the stacking direction 93 to the connection adapter 1. The housing 11 includes on its stacking back 80 a second adapter part A13 (see FIG. 2a) for adapting the second connector panel 3.

The stacking back 80 and the stacking front 88 extend substantially transversely to the stacking direction 93. They are each arranged parallel to a plane, which is spanned by a line (not shown) extending in a conductor insertion direction 92 and by a line (not shown) extending in an extension direction 91. Both the insertion direction 92 and the extension direction 91 extend perpendicularly to the stacking direction 93 and perpendicularly to one another.

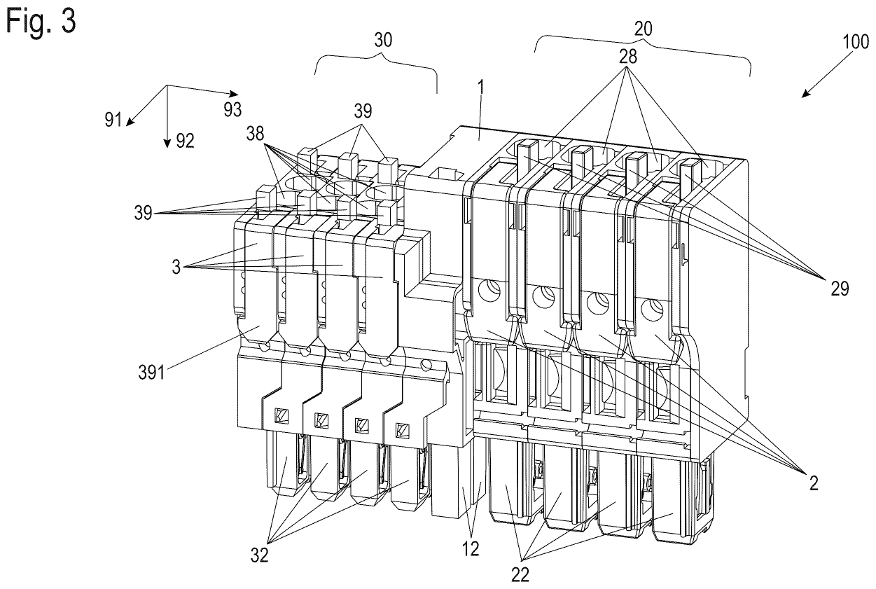

The first connector panel 2 has on its stacking front first fastening mechanisms 26, 27 and on its back mating fastening mechanisms 23, 24, 35 configured to correspond with the first fastening mechanisms with regard to their shape and their dimensions. The second connector panel 3 has on its stacking back second fastening mechanisms 33, 34, 37 and on its front mating fastening mechanisms 35 configured to correspond with the second fastening mechanisms 33, 34, 37 with regard to their shape and their dimensions. The fastening mechanisms 26, 27, 33, 34, 37 and mating fastening mechanisms 23, 24, 35 are configured to interact with one another. As a result, two or more connector panels 2, 3 of the same structural type can be mechanically connected, in particular inserted into another and/or stacked on one another, in and against the stacking direction 93 which extends perpendicularly to the stacking back and/or stacking front of the connector panels 2, 3. Each of the connector panels 2, 3 therefore has on the stacking front or on the stacking back an adapter part A2, A3 (see FIG. 2a) and on its opposite back or stacking front a mating adapter part A2′, A3′ configured in a corresponding manner thereto. As a result, any number of connector panels 2, 3 of the same structural type can be stacked onto one another. A stacking front of a connector panel 2, 3 is in each case joined to a stacking back of a connector panel 2, 3 of the same structural type. Two or more connector panels 2, 3 stacked on one another form a connector 20, 30 (see FIG. 3) of the specific structural type.

For that reason, the fastening mechanisms 13-17, 26, 27, 33, 34, 37 and/or mating fastening mechanisms 23, 24, 35 of the connector panels 2, 3 and/or the connection adapter 1 can include positioning and clamping portions 14, 16, 24, 34, for example pins and recesses, latching portions 13, 15, 17, 23, 27, 33, 35, 37, for example, latching hooks and latching recesses and/or sliding mechanisms.

To stack the first connector panel 2 and the second connector panel 3 onto one another on the connection adapter 1, they are slid onto the connection adapter 1 in or against the stacking direction 93. Positioning and clamping pins 14, 24, 34 can in each case be slid into mating position and clamping recesses 16, wherein they preferably firmly clamp. Furthermore, latching mechanisms, such as latching hooks 17, 23, 35, 37, are slid in into mating snapping or latching mechanisms, such as latching recesses 13, 15, 27, 33, so that they latch to one another.

When first and second connector panels 2, 3 are stacked on the connection adapter 1 on both sides, the connection adapter 1 is arranged between the connector panels 2, 3 to form a connector arrangement 100 (see FIGS. 2, 3) with the panels. Because of this, the connection adapter 1 is configured as a panel, and as a result, the distance between the connector panels 2, 3 is small.

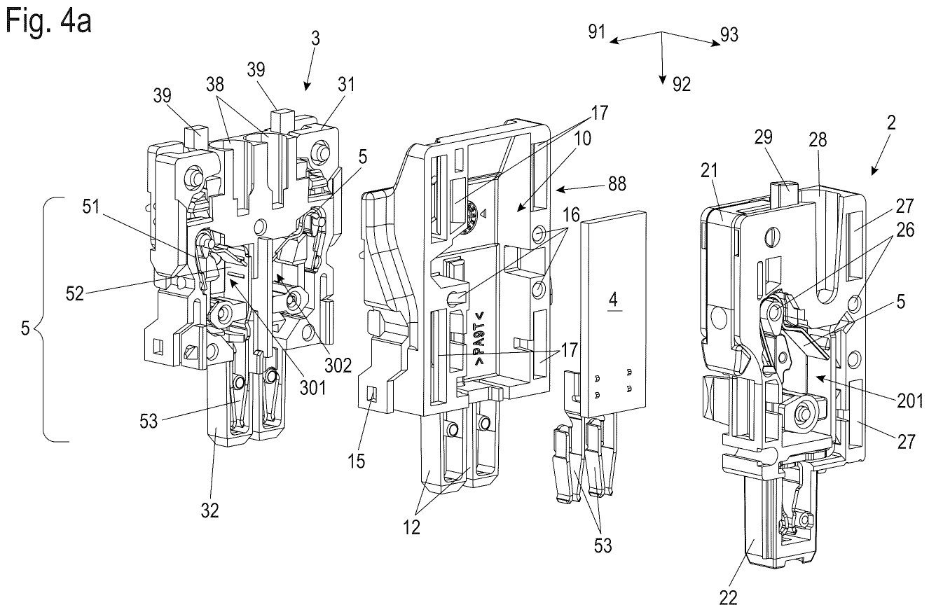

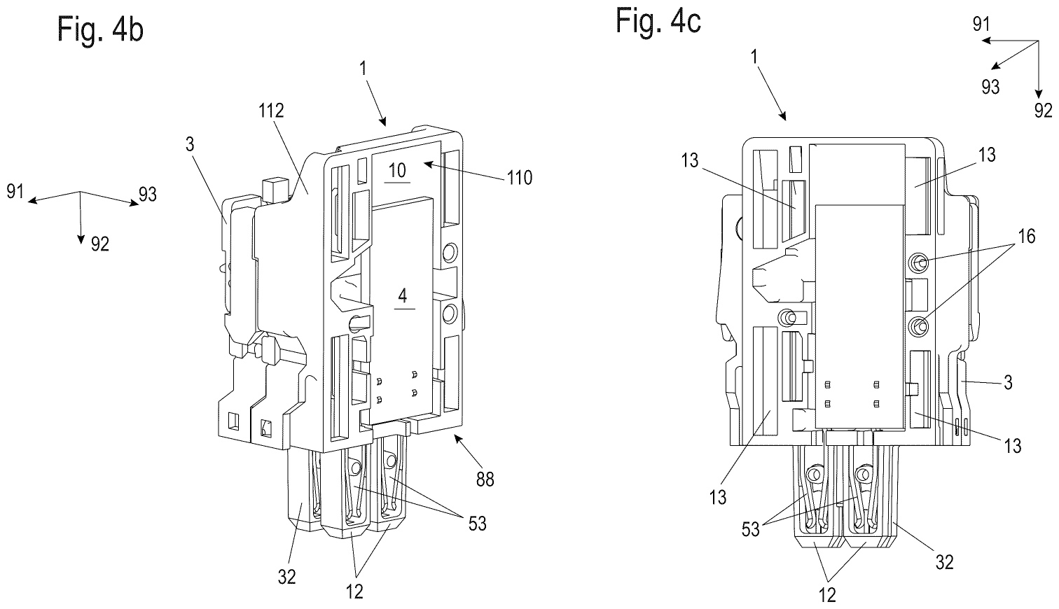

As shown in FIG. 1b, the housing 11 of the connection adapter 1 has on its stacking back a back wall 118 which extends in a planar manner to the edge 128 to a narrow wall 112. Here, the narrow wall 112 is arranged directly at the edge 128 of the back wall 118 and extends transversely thereto. As a result, the dimension of the narrow wall 112 in the stacking direction 93 determines the distance between connector panels 2, 3 fastened on both sides to the connection adapter 1. As shown in FIGS. 4a-4c, the narrow wall 112 extends at a different angle to the back wall, at least in certain areas.

The back wall 118 and the narrow wall 112 are configured approximately in the form of a pot to define an inner space 10. The housing 11 has an opening 110 on the stacking front, so that the inner space 10 is easily accessible from the outside.

The inner space 10 can be provided or utilised for receiving an electrical component, in particular an electrical part or an electrical assembly.

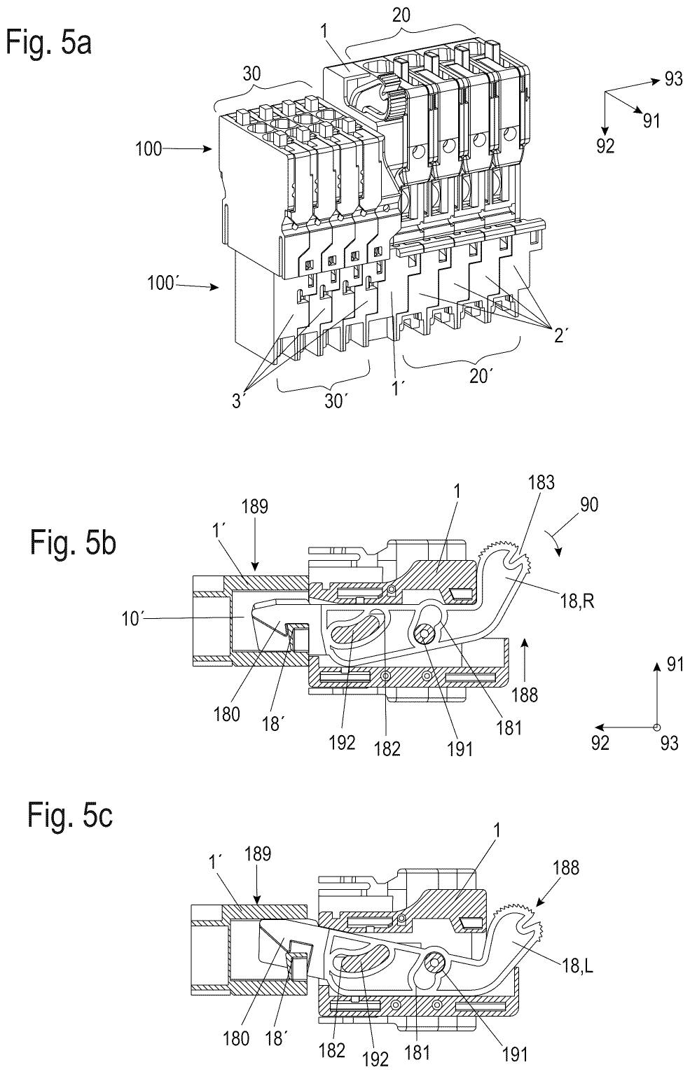

Additionally or alternatively, the inner space 10 can be provided for receiving a locking mechanism 18, as further explained in relation to the description of FIGS. 4a-5c.

Furthermore, a blind housing part 12 can be arranged on the housing 11, which can optionally be provided for receiving at least one contact such as a pin, knife or a socket 53. This is explained within the context of the description of FIGS. 4a-4c. In particular, the blind housing part 12 forms a kind of plugging face of the connection adapter 1.

The blind housing part 12 protrudes from the narrow wall 112 in the conductor insertion direction 92 and has an open end 120. The connection adapter 1 can be inserted into a corresponding mating plugging face (not shown) of a mating connection adapter 1′ (see FIG. 5a) in the conductor insertion direction 92.

FIGS. 2a-2d show a connector arrangement 100 having the connection adapter 1 from FIG. 1, including precisely one first connector panel 2 of the first structural type, which can be arranged on the stacking front of the connection adapter 1, and precisely one second connector panel 3 of the second structural type, which can be arranged on the stacking back of the connection adapter 1.

On the stacking front of the connection adapter 1, the housing 11 has the first adapter part A12 with the fastening mechanism 13, 16 for fastening the first connector panel 2 of the first structural type. The first connector panel 2 of the first structural type has a first mating adapter part A2′ configured in a corresponding manner to the first adapter part A12 of the connection adapter 1 to be fitted onto the first adapter part A12. Accordingly, first mating fastening mechanisms 23, 24 are identically arranged in a corresponding manner with regard to their spatial positioning on the first mating adapter part A2′ of the first connector panel 2.

The housing 11 of the connection adapter 1 has arranged on the stacking back the second adapter part A13 with fastening mechanisms 14, 15, 17 for fastening the second connector panel 3 of the second structural type. The second connector panel 3 of the second structural type has a second mating adapter part A3′ configured in a corresponding manner to the second adapter part A13 of the connection adapter 1. The second adapter part can be fitted onto the second adapter part A13 of the connection adapter 1. Accordingly, second mating fastening mechanisms 33, 34, 37 are identically arranged in a corresponding manner with regard to their spatial positioning on the second mating adapter part A3′ of the second connector panel 3.

FIG. 2d shows latching of the connector panels 2, 3 to the connection adapter 1. The latching hooks 23, 35 of the first and second connector panels 2, 3 are each latched in latching recesses 13, 15 of the connection adapter 1. In addition, the opening of the inner space 10 is closed because the back wall 83 of the second connector panel 3 is latched to the connection adapter 1.

The first and second connector panels 2, 3 are provided for electrically connecting an electrical conductor to an electrical assembly (not shown here), in particular of an electrical device. For that reason, they each have electrical connection terminals 5 (see FIGS. 4a-4c) for electrically connecting at least one electrical conductor to the respective connector panel 2, 3.

FIGS. 2a and 2b show in the connector panels 2, 3 conductor introduction openings 28, 38 for introducing an electrical conductor. In addition, FIGS. 2a-2c show actuation mechanisms 29, 39, here releasing mechanisms, on the connector panels 2, 3, with which the electrical connection terminals 5 can be actuated by actuating the lever 391.

FIG. 3 shows the connector arrangement 100 from FIG. 2, wherein not only is one connector panel 2, 3 of one structural type stacked in each case on the front and stacking back of the connection adapter 1, respectively, but rather multiple connector panels 2, 3 of the same structural type are stacked on one another to form a connector 20, 30.

For that reason, to stack multiple connector panels 2, 3 of the same structural type on one another, adapter parts A2, A3 are provided in each case on the side facing away from the mating adapter part A2′, A3′ (not denoted). The adapter parts A2, A3 are configured in a corresponding manner to their mating adapter parts A2′, A3′. As a result, the connector panels 2, 3 of the same structural type can be stacked on one another in or against the stacking direction 93 to form a connector 20, 30 and the connection adapter 1 can be stacked on the connector 20, 30 in or against the stacking direction.

FIGS. 4a-4c include the plugging faces 22, 32 of the first and the second connectors 20, 30, which differ in terms of the number of the plugs or sockets 53 which can be connected and in terms of their dimensions. Due to the various dimensions of the plugs or sockets 53 of the plugging faces 22, 32, these use various printed circuit board grid pitches.

FIGS. 4a-4c in exploded and perspective representations, respectively, show a connector arrangement 100 having a connection adapter 1 of a further embodiment.

The connection terminals 5 of the first and the second connector panel 2, 3, to which an electrical conductor can be connected, are shown in the exploded representation of FIG. 4a. Here, the electrical connection terminals 5 are configured as direct plug-in terminals. The first connector panel 2 of the first structural type has precisely one direct plug-in terminal 5 for connecting an electrical conductor and the second connector panel 3 of the second structural type has two direct plug-in terminals 5 for connecting an electrical conductor. The terms electrical connection terminal 5 and direct plug-in terminal are used interchangeably below.

The direct plug-in terminals 5 are arranged in an inner space part of the connector panels 2, 3 configured as a conductor clamping space 201, 301, 302. They are explained below with reference to a direct plug-in terminal 5 of the second connector panel 3.

The direct plug-in terminal 5 can have a spring terminal 51 configured with an approximate V-shape, having a supporting leg and a clamping leg, wherein the supporting leg is supported on an abutment, here on the housing 31. The clamping leg is provided to clamp an electrical conductor that is slid into the conductor clamping space 301, through the conductor insertion opening 38, in the conductor insertion direction 92, and on a busbar 52 of the direct plug-in terminal 5. The busbar 52 is connected to a socket 53 of the plugging face 32 in an electrically conductive manner. The actuation mechanism 39 is provided for releasing the electrical conductor from the direct plug-in terminal 5. By displacing, or in other words pressing, the actuation mechanism 39 onto the clamping leg, the clamping leg is pushed away from the busbar 52, so that the electrical conductor is set free. It can then be extricated from the direct plug-in terminal 5 against the conductor insertion direction 92. For an actuation which requires less force, the lever 391 can also be utilised to actuate the actuation mechanism 39.

The connection adapter 1 includes the inner space 10 to receive an electrical component. The electrical component is arranged on an electrical printed circuit board 4 or can comprise such an electrical printed circuit board, which can be slid into the inner space 10 through the opening 110. Two sockets 53 are arranged on the printed circuit board 4, which are electrically connected to the electrical component and are received in the plugging face 12 of the connection adapter 1 when the electrical component is arranged in the inner space 10. The sockets 53 can be provided to supply voltage to the electrical component. However, they can optionally or alternatively be designed for signal transmission.

FIGS. 4b and 4c do not include the connector panel 2 so as to show the mounted printed circuit board 4 being received in the inner space 10 and the sockets 53 being received in the plugging face 12 of the connection adapter 1.

FIG. 5a shows a connector arrangement 100 having a further embodiment of a connection adapter 1, which is inserted into a mating connector arrangement 100′ configured in a corresponding manner to the connector arrangement 100. FIGS. 5b and 5c each show a sectional view through the connection adapter 1 of FIG. 5a.

The mating connector arrangement 100′ can have a first mating connector 20′ comprising multiple (here, four) first mating connector panels 2′ of the first structural type, which are configured in a corresponding manner to the first connector panels 2 or to the first connector 20 of the first structural type of the connector arrangement 100. Furthermore, it can have a second mating connector 30′ comprising multiple (here, four) second mating connector panels 3′ of the second structural type, which can be configured in a corresponding manner to the second connector panels 3 or to the second connector 30 of the second structural type of the connector arrangement 100. The first and second mating connector panels 2′, 3′ are respectively stacked on one another in the stacking direction 93 of the first and the second mating connectors 20′, 30′. Furthermore, the mating connector arrangement 100′ has a mating connection adapter 1′ which is arranged between the mating connectors 20′, 30′. The mating connection adapter 1′ is configured in a corresponding manner to the connection adapter 1. The mating connector arrangement 100′ is provided to be arranged on an electrical device printed circuit board, in particular of an electrical device. For that reason, the mating connector panels 2′, 3′ have, in each case, a corresponding mating socket or mating plug for each plug or socket 53 of the connector panels 2, 3. These can be electrically connected to a solder point or an electrical conductor path of the electrical device printed circuit board.

In FIG. 5a, the connector arrangement 100 is inserted into the mating connector arrangement 100′. The first connector 20 and the second connector 30 of the connector arrangement 100 are identical in construction to those of FIG. 3. However, the connection adapter 1 of this connector arrangement 100 differs from that of the connector arrangement 100 of FIG. 3.

Instead of the electrical printed circuit board 4, as shown in FIGS. 4a-4c, a locking mechanism 18 is arranged in the inner space of the connection adapter 1 of FIG. 5. The locking mechanism 18 extends in the conductor insertion direction 92 and completely pushes through the connection adapter 1. At an actuation end 188 and an insertion end 189, it protrudes from the connection adapter 1 over the latter. At its actuation end 188, a slot is provided as an actuation mechanism 183, into which slot a screwdriver actuates the locking mechanism 18. Manual actuation is also possible without tools. A latching hook 180 is provided at its insertion end 189 to engage, from behind, a locking contour of a mating latching mechanism 18′ of the mating connection adapter 1′.

The locking mechanism 18 is configured as a lever, which can be reversibly swivelled from a latching position R, shown in FIG. 5b, into a releasing position L, shown in FIG. 5c, about a swivelling bearing 191. In FIG. 5b, the connection adapter 1 is inserted into the mating connection adapter 1′. The latching hook 180 of the locking mechanism 18 is introduced into an inner space 10′ of the mating connection adapter 1′ and engages the mating latching mechanism 18′ from behind so that these are latched to one another. FIG. 5c shows the release, or pulling away, of the mating connection adapter 1′ from the connection adapter 1.

When the locking mechanism 18 is swivelled around the swivelling bearing 191, it is swivelled and displaced along a swivelling and guide contour 181. In addition, the locking mechanism 1 has a guide contour 182 which, when the locking mechanism 1 is swivelled and displaced, slides along a guide 192 which is provided in the inner space of the connection adapter 1. As a result of this embodiment, the locking mechanism 18 automatically locks when the connection adapter 1 is inserted into the mating connection adapter 1′. The locking mechanism 18 guarantees secure mechanical locking of the connection adapter 1 to the mating connection adapter 1′or of the connector arrangement 100 to the mating connector arrangement 100′.

As well as with the locking mechanism 18, the electrical component could also be received in the inner space 10 of the connection adapter 1.

What is claimed is:

1. A connection adapter for mechanically fastening electrical connector panels having various structures and configured to be stacked in a stacking direction onto one another to form a connector arrangement, the connection adapter including a housing, comprising:
a. a stacking front having fastening mechanisms configured for a first structure being arranged thereon for fastening a first electrical connector panel having the first structure against a stacking direction with the connection adapter; and
b. a stacking back having fastening mechanisms configured for a second structure being arranged thereon for fastening a second electrical connector panel of the second structure in the stacking direction with the connection adapter.

2. The connection adapter according to claim 1, wherein the fastening mechanisms comprise one of positioning and clamping mechanisms and latching mechanisms.

3. The connection adapter according to claim 1, the connection adapter having a panel configuration, wherein the housing has a planar back wall extending on the stacking back to and connected with a narrow wall being arranged at an angle relative to the back wall, the back wall and the narrow wall define an inner space containing an opening on the stacking front of the housing.

4. The connection adapter according to claim 3, wherein the inner space is provided for receiving at least one electrical component being one of an electrical part and an electrical assembly.

5. The connection adapter according to claim 4, and further comprising at least one blind housing part including a plugging face provided for receiving one of a plug and a socket.

6. The connection adapter according to claim 5, wherein the electrical component comprises an electrical printed circuit board.

7. The connection adapter according to claim 6, wherein the plug or socket electrically contacts the printed circuit board, is arranged in the blind housing part and is provided for at least one of voltage supply and communication of the electrical component with at least one of the connector panels.

8. The connection adapter according to claim 1, wherein electrical connection mechanisms for contacting at least one of the first and second connector panels are provided on one of the stacking back and stacking front of the housing.

9. The connection adapter according to claim 4, wherein the electrical component is configured to identify a structural type of at least one of the first and second electrical connector panels.

10. The connection adapter according to claim 1, wherein the housing includes at least one indicating mechanism for indicating a status of at least one of the first and second electrical connector panels, the indicating mechanism being a lighting mechanism.

11. The connection adapter according to claim 3, wherein the inner space is configured to receive a locking mechanism for locking a corresponding mating connection adapter.

12. The connection adapter according to claim 11, wherein the locking mechanism includes a lever on which a latching hook is arranged and which can be adjusted from a latching position to a releasing position.

13. A connector arrangement comprising a connection adapter according to claim 1 and at least one of a first connector panel having a first structure and a second connector panel having a second structure, wherein the first connector panel is fastened to the stacking front of the connection adapter and the second connector panel is fastened to the stacking back of the connection adapter.

14. The connector arrangement according to claim 13, wherein the fastening mechanisms of the connection adapter stacking front have a configuration identical to first connector panel fastening mechanisms and corresponding to first connector mating mechanisms, the fastening mechanisms of the connection adapter stacking back having a configuration identical to second connector panel fastening mechanisms and corresponding to second connector panel mating fastening mechanisms.

15. The connector arrangement according to claim 13, wherein the first and second connector panels each have at least one connection terminal for electrically connecting electrical conductors to an electrical mating connector panel.
